(19) United States
(12) Patent Application Publication
(10) Pub. No.: US 2014/0358520 A1
(43) Pub. Date: Dec. 4, 2014

(54) REAL-TIME ONLINE AUDIO FILTERING

(71) Applicant: THOMSON LICENSING, Issy de Moulineaux (FR)

(72) Inventor: Martin Vincent DAVEY, Indianapolis, IN (US)

(21) Appl. No.: 13/906,407

(22) Filed: May 31, 2013

(51) Int. Cl. G06F 17/27

(52) U.S. Cl. CPC G06F 17/2765
USPC 704/9

(57) ABSTRACT

Audio from online, real-time activity is routed through a filter to remove inappropriate language associated with parameters received by a user interface. The filter automatically removes audio based on the parameters and/or derived parameters. The parameters can be directly input by a user and/or a list can be provided to the user from which they select their desired parameters.

### BACKGROUND

All video games contain ratings so that parents can judge if the content is appropriate for their children. However, when playing games online, parents may not be aware of whom their children are playing with. These unknown players could be using language that the parents believe to be inappropriate for the age of their children. Currently, there is no means for the parents to monitor the audio during game play and intercept inappropriate language before it reaches their children. Most games have a mechanism to complain about language use during game play, but this is an after the fact solution and still leaves the child exposed to the inappropriate language.

### SUMMARY

The audio from online, real-time games is routed through a filter to mute/remove inappropriate language. This prevents a player from receiving/hearing the filtered language. Parents can set the filter to block a standard set of undesirable language and/or to provide a custom/customized list for the filter to use. The filtering set of parameters can also be presented to a user as a customized list based on a player's age and/or the player themselves.

The above presents a simplified summary of the subject matter in order to provide a basic understanding of some aspects of subject matter embodiments. This summary is not an extensive overview of the subject matter. It is not intended to identify key/critical elements of the embodiments or to delineate the scope of the subject matter. Its sole purpose is to present some concepts of the subject matter in a simplified form as a prelude to the more detailed description that is presented later.

To the accomplishment of the foregoing and related ends, certain illustrative aspects of embodiments are described herein in connection with the following description and the annexed drawings. These aspects are indicative, however, of but a few of the various ways in which the principles of the subject matter can be employed, and the subject matter is intended to include all such aspects and their equivalents. Other advantages and novel features of the subject matter can become apparent from the following detailed description when considered in conjunction with the drawings.

### BRIEF DESCRIPTION OF THE DRAWINGS

FIG. 1 is an example of a system for a wide area network linked system.

FIG. 2 is an example of a system that provides audio filtering for a local based device.

FIG. 3 is an example of a system that filters online audio.

FIG. 4 is a flow diagram of a method of filtering online audio.

### DETAILED DESCRIPTION

The subject matter is now described with reference to the drawings, wherein like reference numerals are used to refer to like elements throughout. In the following description, for purposes of explanation, numerous specific details are set forth in order to provide a thorough understanding of the subject matter. It can be evident, however, that subject matter embodiments can be practiced without these specific details. In other instances, well-known structures and devices are shown in block diagram form in order to facilitate describing the embodiments.

As online games become more common, the interaction between players is just not seen on a screen. Users often use headsets to talk and listen and interact with other players. The game providers rate their games based on the content of the game material, but cannot control player's reactions to the content. Thus, there is no way to rate the language of the other players as the game is being played. So, a player can use inappropriate language while playing games, subjecting all of the other players to language that can be well beyond the rating of the game material. This is a particular problem to parents who do not want their young children exposed to inappropriate language. Banning them from playing the game altogether is often not a viable solution.

There are several common ways to avoid the issue of inappropriate language—one can mute the audio of the game and/or one can opt to not use headsets to interact with other players. This is often not an optimal solution, especially in online games involving team playing where team members need verbal directions from other team members. However, techniques disclosed herein utilize real-time monitoring systems for communications links, filtering inappropriate language. The amount and/or level of the filtering can be determined by parental controls, user controls and/or automated controls and the like through the setting of parameters for the filter. For example, a parent can use a standardized set of words from a filtered word list and/or the parent can customize a given word list.

The real-time monitoring system can be integrated on a server side where games are hosted and a parent can log-in (e.g., via a browser page and the like) to set a desired filtering level. A system can also be located within a gaming device and/or computing device itself. A system can also be located external to a gaming device. For example, a parent can use parental controls to mute bad language with an easy to use interface. The interface can be, for example, a web browser page where a user is presented with pre-defined lists based on age, sex, and/or identity of person playing a game and the like. Thus, for example, a parent can just check a single box labeled “age appropriate language for a five year old” or select a customized list created for “Jimmy” and the like.

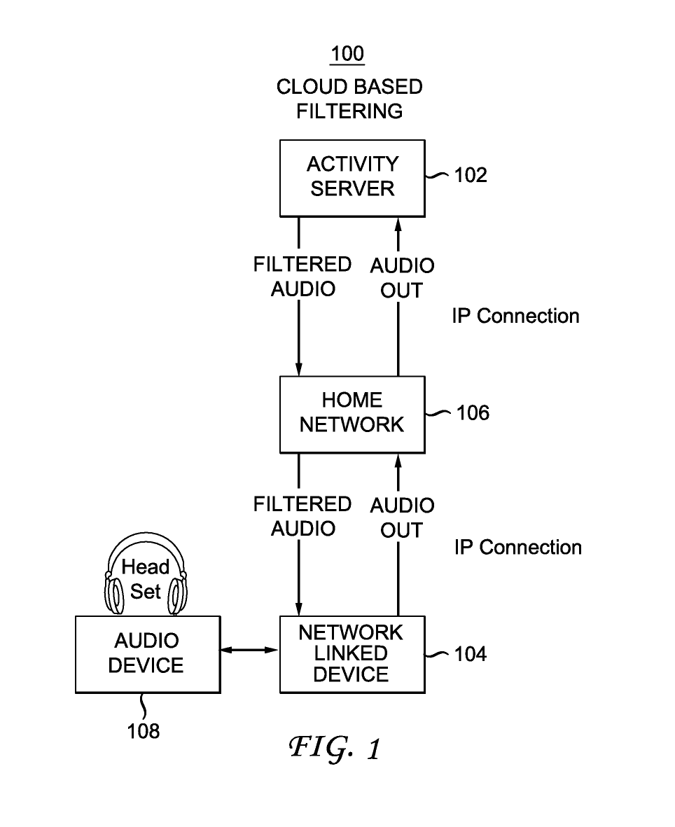

Although applicable to online gaming, the techniques herein can also be utilized for other online activities which incorporate audio as part of their activity and, thus, are not limited to just gaming. FIG. 1 shows an example of a system 100 for a wide area network linked system (e.g., an “online gaming system”). The system 100 includes an online activity server 102 that interacts with a network linked device 104 through a home network 106. The communications between the server 102, home network 106 and network linked device 104 can be wired and/or wireless communications such as, for example, WiFi, Bluetooth, Ethernet, satellite, cable and/or fiber optic and the like. One skilled in the art can appreciate that the network linked device 104 can also directly communicate with the activity server 102. This can be accomplished, for example, via cellular communications (e.g., 3GS, 4GS, LTE, etc.), its own WAN connection, and/or satellite communications and the like. In one example, audio from an optional audio device 108 such as, for example, a headset for the network linked device 104 is sent to the activity server 102 via the home network 106. Based on filtering parameters (e.g., parental control parameters and the like), the audio can be filtered or not and sent back to the network linked device 104. The activity server 102 can be, but is not limited to, an online gaming server, an online chat server and/or an online video chat server and the like. In a similar fashion, the network linked device 104 can be a gaming device, a computing device, a mobile device (e.g., a cell phone, smart phone, tablet, etc.) device and the like.

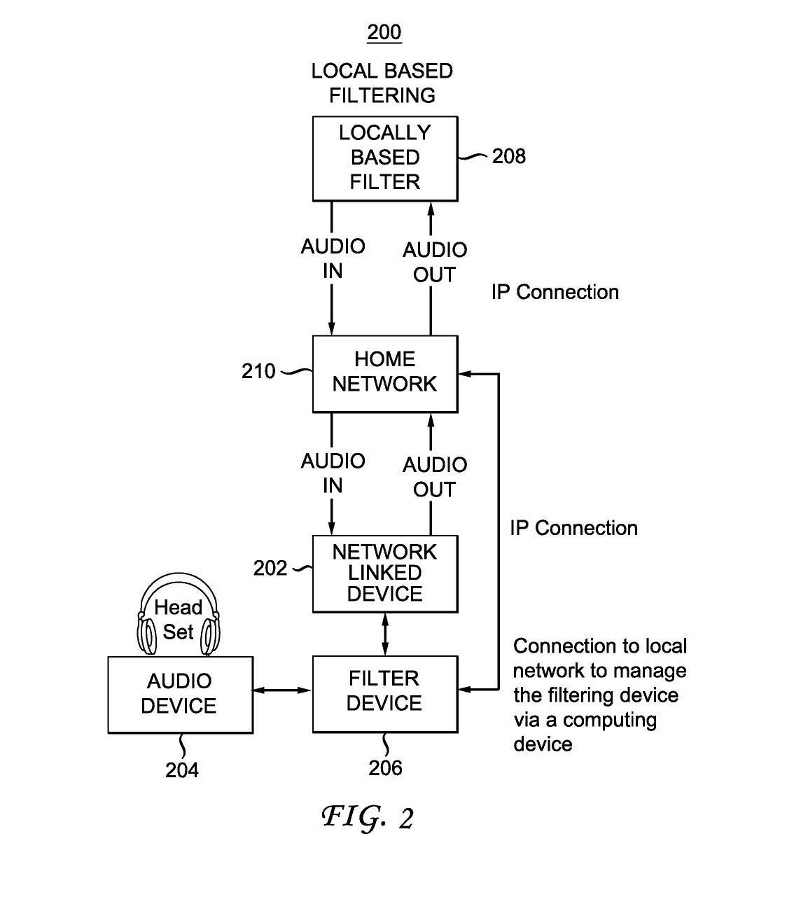

FIG. 2 illustrates an example of a system 200 that provides audio filtering for a locally based device. In this example, a network linked device 202 interfaces with an audio device 204 (e.g., a headset, microphone, etc.) through a filter device 206. The network linked device 202 communicates with a locally based filter 208 via a home network 210. The locally based filter 208 can reside within a computing device such as a personal computer, a television, a set top box and/or other products and the like. The filter device 206 communicates with the locally based filter 208 via the home network 210 to relay filtering parameters. Thus, audio from the audio device 204 is sent to the filter device 206 and, based on the filtering parameters (e.g., parental control parameters, etc.), the audio is filtered or not.

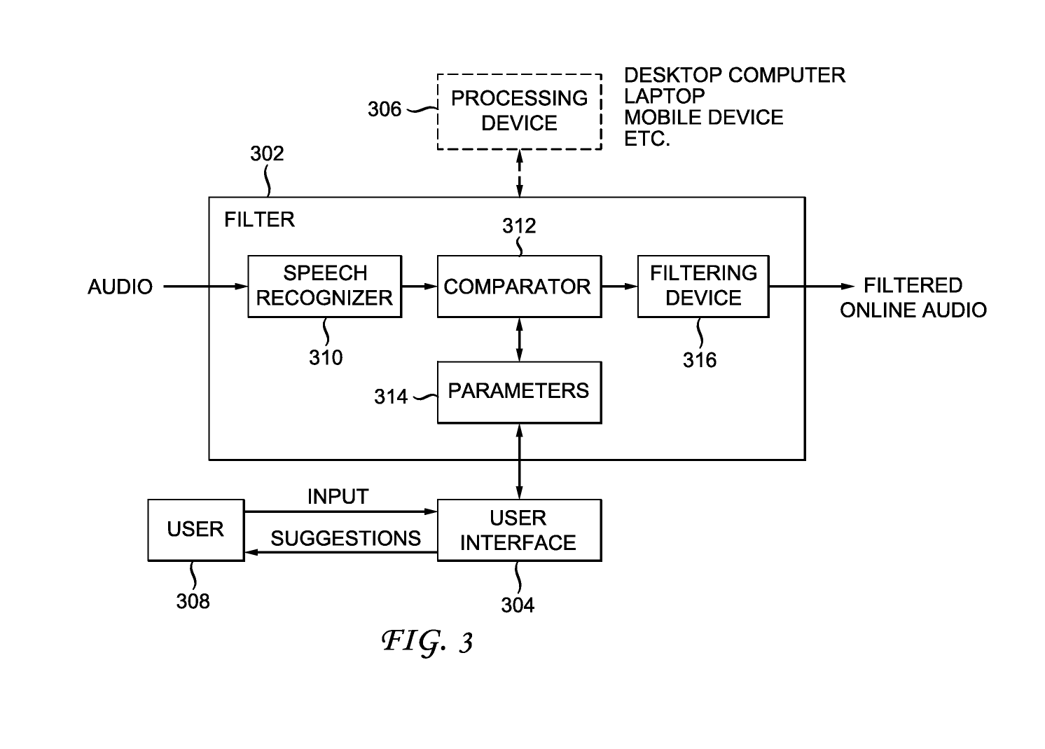

An example system 300 that filters online audio is illustrated in FIG. 3.

The system 300 includes a filter 302 that interacts with a user interface 304 and an optional processing device 306. The user interface 304 can accept input from a user 308 and/or it 304 can also provide parameter suggestions to the user 308. The filter 302 receives audio and filters the audio based on parameters that can be provided by the user interface 304 to yield filtered audio for real-time online activities (e.g., video chatting, gaming, etc.). The filter 302 includes a speech recognizer 310, a comparator 312 and a filtering device 316. The comparator 312 interacts with parameters 314 that can be stored in a database and/or relayed in real-time to the comparator 312. The user interface 304 can be used to supply a parameter provided by the user 308.

The speech recognizer 310 can utilize, for example, speech-to-text technologies and/or audio envelope recognition technologies and the like. In one scenario, the parameters 314 include words that the user 308 desires to have filtered. The speech recognizer 310 converts the audio to text and the comparator 312 compares the converted speech to prohibited words from the parameters 314. Matches/near matches in the comparator 314 are passed to the filtering device 316 and are muted/removed from the outgoing filtered audio. In yet another scenario, the speech recognizer 310 recognizes a signal “envelope” of a word in the audio and marks the beginning and ending of the word. As one speaks a word, it forms a signal envelope based on frequencies and/or timing and loudness involved in pronouncing the word. Each envelope is fairly unique based on the speech pattern of a speaker. The parameters 314 can now include signal envelopes of prohibited words which are supplied to the comparator 312. The comparator compares the incoming audio from the speech recognizer 310 to the parameters using the audio envelopes found and marked with timing by the speech recognizer 310. When a prohibited envelope (i.e., a match and/or a near match) is found, the comparator 312 notifies the filtering device 316 to mute and/or otherwise remove that word/language from the outgoing filtered audio. This can be accomplished by using the timing information from the speech recognizer 310.

Some speech recognizer functions can be very processor intensive. For these situations where the filter 302 does not have enough processing power to filter in real-time, it can utilize the optional processing device 306. The optional processing device 306 can reside in a mobile and/or non-mobile device and the like (e.g., cell phone, laptop, set top box, television, etc.). For example, a desktop computer can provide the processing power as well as a smart mobile phone. Communications between the filter 302 and the processing device 306 can be, but are not limited to, wired and/or wireless connections (e.g., Bluetooth, WiFi, etc.). The amount of communications can be reduced by feeding the audio directly into the processing device 306 and transmitting only the found text and/or audio envelopes to the comparator 312.

A user and/or a system can facilitate a speech recognition process by training and/or otherwise tuning the recognition until a desired result is achieved. Some recognition systems automatically learn and increase in accuracy the longer a speaker talks. Likewise, if the filtering does not produce the desired result, a user can adjust the filter to compensate. This can include, but is not limited to, adjusting the amount of acceptable “near matches” found by the comparator 312. A value pertaining to acceptable levels of matching can be adjusted by the system and/or by a user and the like to increase filtering of the audio. In a similar fashion, it can be adjusted to reduce the amount of filtering if it is deemed too stringent by a user and/or by a system and the like.

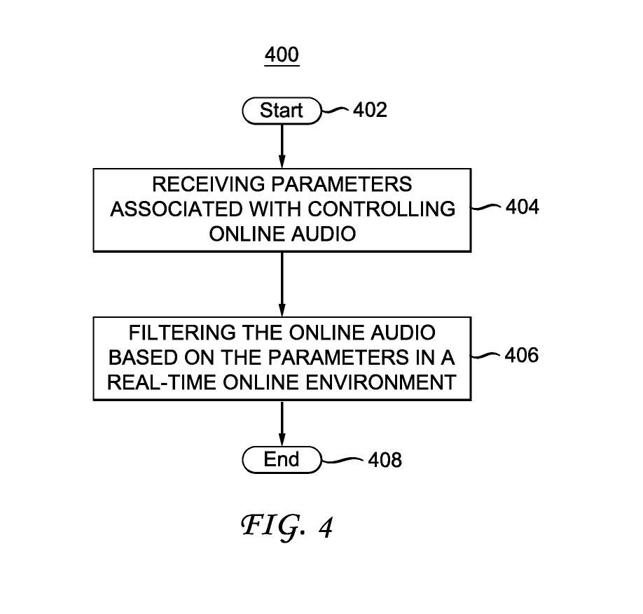

In view of the exemplary systems shown and described above, methodologies that can be implemented in accordance with the embodiments will be better appreciated with reference to the flow charts of FIG. 4. While, for purposes of simplicity of explanation, the methodologies are shown and described as a series of blocks, it is to be understood and appreciated that the embodiments are not limited by the order of the blocks, as some blocks can, in accordance with an embodiment, occur in different orders and/or concurrently with other blocks from that shown and described herein. Moreover, not all illustrated blocks may be required to implement the methodologies in accordance with the embodiments.

FIG. 4 is a flow diagram of a method 400 of filtering online audio. The method starts 402 by receiving parameters associated with controlling online audio 404. These parameters can be set by a user through a standardized list and/or a customized list. The parameters can also be set by a system automatically. This can occur when, for example, a user/player is identified. For example, player “Jimmy,” of an online game, when identified can be automatically set to “age appropriate language for five year olds” and the like. It is also possible for a system to track the frequency of use of prohibited language and/or of particular words. If a frequency reaches a certain threshold, that user's audio can be completely muted/removed and the like and/or a notification can be sent to a parent and/or other user notifying them in real-time that bad language is being used frequently by user X and the like. The audio is then filtered based on the parameters in a real-time online environment 406, ending the flow 408. The filtering process can utilize additional resources that can facilitate the filtering processes. These resources can be mobile and non-mobile devices like smart phones, laptops, televisions, set top boxes and/or desktop computers and the like. It can also utilize a gaming console. The filtering occurs in real-time so that the player is not exposed to the inappropriate language. If the filtering is too prohibitive, the amount of “near matching” can be reduced. If the filtering is ineffective, the amount of “near matching” can be increased to include more variations of a given set of parameters. This can be done automatically and/or via a user's input to a system.

What has been described above includes examples of the embodiments. It is, of course, not possible to describe every conceivable combination of components or methodologies for purposes of describing the embodiments, but one of ordinary skill in the art can recognize that many further combinations and permutations of the embodiments are possible. Accordingly, the subject matter is intended to embrace all such alterations, modifications and variations that fall within scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

1. A system that filters online audio, comprising:
a comparator that compares audio language to given parameters; and
a filtering device that filters audio language in a real-time online environment when the comparator finds a given parameter in the audio.

2. The system of claim 1, wherein the audio is from at least one of online gaming and online video chatting.

3. The system of claim 1 further comprising:
a user interface that accepts parameters associated with controlling audio.

4. The system of claim 3, wherein the user interface provides acceptable parameters for a user to select from.

5. The system of claim 1, wherein the system resides in proximity of a network linked device.

6. The system of claim 5, wherein the system utilizes an external processing device to facilitate filtering of the audio.

7. The system of claim 1, wherein the system resides external to a network linked device.

8. The system of claim 7, wherein the system filters audio in a remote server as the audio passes through the server.

9. The system of claim 1, wherein the system interfaces with an audio device of a network linked device.

10. The system of claim 1, wherein the system automatically determines a filtering parameter.

11. The system of claim 1 is a gaming console.

12. A method for filtering online audio, comprising the steps of:
receiving parameters associated with controlling online audio; and
filtering the audio based on the parameters in a real-time online environment.

13. The method of claim 12 further comprising the step of:
providing a user interface for a user to input parameters to be utilized in filtering the audio.

14. The method of claim 12 the step of filtering the audio further comprising:
filtering the audio in a remote server that provides online services.

15. The method of claim 12 the step of filtering the audio further comprising:
using an external processing device to facilitate filtering of the audio.

16. A system that filters online audio, comprising:
a means for receiving parameters associated with controlling audio; and
a means for filtering the audio based on the parameters in a real-time online environment.

17. The system of claim 16 further comprising:
a means for filtering the audio in a remote server that processes online activity.
